(19) United States
(12) Patent Application Publication
(10) Pub. No.: US 2020/0026389 A1
(43) Pub. Date: Jan. 23, 2020

(54) ELECTRONIC WHITEBOARD CAPABLE OF SIMULTANEOUS WRITING AND PROJECTION STORAGE

(71) Applicant: Suzhou Maxpad Technologies Co., Ltd, Jiangsu Province (CN)

(72) Inventor: MING-TANG TSAI, Taipei City (TW)

(21) Appl. No.: 16/039,785

(22) Filed: Jul. 19, 2018

(51) Int. Cl. G06F 3/042; H04N 9/31; G06K 9/00; G06F 3/0488

(52) U.S. Cl. CPC G06F 3/0425; G06F 3/04883; G06K 9/00597; H04N 9/31

(57) ABSTRACT

The present invention discloses an electronic whiteboard capable of simultaneous writing and projection storage, including two groups of infrared camera modules which are mirror-symmetrical and separate an electronic whiteboard body into a left-region electronic whiteboard and a right-region electronic whiteboard. A first projector connected to the left-region electronic whiteboard/right-region electronic whiteboard is disposed at the top of the left-region electronic whiteboard/right-region electronic whiteboard. A touch mainboard of the left-region electronic whiteboard/right-region electronic whiteboard without the first projector is connected to a computer host of the electronic whiteboard computer. The computer host is connected, through the first projector, to the touch mainboard of the left-region electronic whiteboard/right-region electronic whiteboard that is provided with the first projector. The interaction effect on and off the stage are enhanced.

### TECHNICAL FIELD

The present invention relates to the field of electronic whiteboards, and in particular, to an electronic whiteboard capable of simultaneous writing and projection storage.

### BACKGROUND ART

An electronic whiteboard combines advantages of the modern computer technology, Internet information, multimedia resources and professional software, can retrieve teaching and meeting information (texts, pictures, courseware, videos, and so on) conveniently, and can present the information vividly with a large screen. The electronic whiteboard is widely applied in educational training and office meetings. However, it is still necessary to write with a conventional whiteboard marker in a current class or meeting to assist in teaching or presenting meeting issues and processes. If a user switches between writing with whiteboard marker and playing information with a projector frequently, the operation is relatively complex. The user writes content on the whiteboard and waits till audience finishes copying the content, and then deletes the content to play teaching and meeting information, which also affects efficiency and an interaction effect.

### SUMMARY OF THE INVENTION

In order to overcome the foregoing disadvantages, an objective of the present invention is to provide an electronic whiteboard capable of simultaneous writing and projection storage that enhances the teaching and meeting efficiency and an interaction effect on and off the stage. In order to achieve the foregoing objective, the present invention employs the following technical solution: An electronic whiteboard capable of simultaneous writing and projection storage includes an electronic whiteboard body. An optical reflection bar is disposed on an inner side of a frame of the electronic whiteboard body. Two groups of infrared camera modules are disposed in the middle of the frame, where the two groups of the infrared camera modules are mirror-symmetrical on the left and right and separate the electronic whiteboard body into a left-region electronic whiteboard and a right-region electronic whiteboard. Each group of the infrared camera module includes infrared cameras disposed on upper and lower ends of the inner side of the frame, the two infrared cameras on the left face the optical reflection bar in the left-region electronic whiteboard, and the two infrared cameras on the right face the optical reflection bar in the right-region electronic whiteboard. Touch mainboards of the left-region electronic whiteboard and the right-region electronic whiteboard are each connected to the two infrared cameras of the electronic whiteboard in the corresponding region. A first projector connected to the left-region electronic whiteboard/right-region electronic whiteboard is disposed at the top of the left-region electronic whiteboard/right-region electronic whiteboard. The left-region electronic whiteboard and the right-region electronic whiteboard are each provided with a built-in touch mainboard. The touch mainboard of the left-region electronic whiteboard/right-region electronic whiteboard without the first projector is connected to an input end of a computer host of an electronic whiteboard computer. An output end of the computer host is connected, through the first projector, to the touch mainboard of the left-region electronic whiteboard/right-region electronic whiteboard that is provided with the first projector.

The electronic whiteboard capable of simultaneous writing and projection storage of the present invention has the following beneficial effect: Information can be written on the electronic whiteboard by using a marker while presented through a projector. Using writing on the left-region electronic whiteboard and projection storage on the right-region electronic whiteboard as an example, when touch or writing is performed on the left-region electronic whiteboard, light-sensitive chips of the two vertically adjacent infrared cameras of the left-region electronic whiteboard capture reflected light signals and transmit the signals to the touch mainboard of the left-region electronic whiteboard. The touch mainboard of the left-region electronic whiteboard performs calculation and analysis on data by using an infrared touch triangle algorithm to obtain touch position information and a writing track. The touch mainboard of the left-region electronic whiteboard transmits captured data signals such as a marker writing coordinate track to the computer host in real time. The computer host transmits the marker writing coordinate track to the first projector at the top of the right-region electronic whiteboard. In this case, an effect of writing on the left-region electronic whiteboard and projection storage on the right-region electronic whiteboard is implemented, thus solving the problem that efficiency and an interaction effect are affected as a user writes content on the whiteboard and waits till audience finishes copying the content, and then deletes the content to play teaching and meeting information. In addition, the left-region electronic whiteboard and the right-region electronic whiteboard are not separated by a frame in the middle and form an integrated large-size panel. Two groups of infrared cameras are employed and disposed in a mirror-symmetrical manner, so that a projection touch area that is approximately the same size as an effective touch region can be increased in one time. As a further improvement of the present invention, users' demand on intelligent products and whole-picture touch operations on a full screen with an increased size also grow continuously because electronic whiteboards are increasingly applied in the field such as education, homes, and commercial offices. However, the electronic whiteboards are restricted by many conditions such as an LED light emitting direction and an effective area of an infrared touch module as well as a projection range of a projector. A common measure on the market is simply assembling an electronic whiteboard with a green board; or setting an effective touch area of the electronic whiteboard as a touch region and setting a region out of the touch region as a write-only region; or putting two electronic whiteboards together. These measures can increase the size of the electronic whiteboard to some degree. However, the touch region of the electronic whiteboard is limited, and cannot meet the requirement of a whole-picture touch operation on a super-large full screen. In order to solve this problem, the electronic whiteboard capable of simultaneous writing and projection storage of the present invention further includes a second projector. The first projector and the second projector are correspondingly disposed at the top of the left-region electronic whiteboard and the top of the right-region electronic whiteboard. Output ends of the touch mainboard of the left-region electronic whiteboard and the touch mainboard of the right-region electronic whiteboard are connected to the electronic whiteboard computer. A computer host adapter board is disposed above the electronic whiteboard computer. An output end of a Picture Recognition System (PRS) module of the computer host adapter board is connected to input ends of the first projector and the second projector through HDMI cables respectively, thus meeting the requirement of a whole-picture touch operation on a super-large full screen. The projectors connect electrical signals of the touch regions of the electronic whiteboard to the PRS module through the HDMI cables, and the PRS module projects electrical signal information to the entire electronic whiteboard.

Preferably, an output end of the PRS module of the computer host adapter board is connected to an input end of a projection fusion machine. An output end of the projection fusion machine is connected to the input end of the first projector and the input end of the second projector respectively. The projection fusion machine is built in the computer host adapter board. In combination with an image edge fusion program of the projection fusion machine, the PRS module gradually lowers the brightness of an overlapping part between images of the two projectors, so that the brightness of the whole picture is consistent, and the color of the overlapping area is consistent with colors nearby. Images of two or more projectors are fused to build a display system with a super-large screen, thus forming an integrated image page that can display high-definition images. Preferably, an assembly direction of a lens of each infrared camera is set at an angle of 45° with respect to an upper edge/a lower edge of the frame, so as to reduce touch blind regions and edge interference.

Preferably, the two groups of the infrared camera modules are disposed at a middle position, a left position or a right position of the frame.

Preferably, the infrared cameras are disposed in a camera corner fitting base. AR glass is attached at a visual angle window of the camera corner fitting base. Two sides of a glass substrate of the AR glass are coated with multiple layers of anti-reflection films. The substrate is subject to high-temperature heating in a vacuum furnace as well as surface auxiliary material evaporation and vaporization processes, so that multiple layers of anti-reflection films are coated on two sides of the glass to change the reflection direction and wavelength of incident light on the surface of the glass, thus reducing reflection energy loss when the light passes through the glass, hence increasing effective light transmittance of the glass and also increasing the glass strength. As such, it is prevented that dust enters the infrared camera or the lens surface of the infrared camera is damaged by an external force. Moreover, normal touch operations of the electronic whiteboard will not be affected due to high optical loss of external components.

Preferably, the frame of the left-region electronic whiteboard and the right-region electronic whiteboard is provided with built-in 3D high-definition iris cameras at the top. The 3D high-definition iris cameras are connected to the electronic whiteboard computer. An iris photographing technology is used for facial recognition and gesture control as well as daily network video interaction, and so on.

Preferably, the computer host adapter board is disposed above the rear of the electronic whiteboard body, thus facilitating transmission between multiple external electronic products and the computer of the electronic whiteboard, expanding the product usage range, and making wiring of the external electronic products neat and beautiful.

### BRIEF DESCRIPTION OF THE DRAWINGS

FIG. 1 is a schematic structural diagram of this embodiment;

FIG. 2 is a schematic structural diagram when a left-region electronic whiteboard is used for writing and a right-region electronic whiteboard is used for projection storage according to this embodiment;

FIG. 3 is a working principle diagram of FIG. 2; and

FIG. 4 is a schematic structural diagram when the right-region electronic whiteboard is used for writing and the left-region electronic whiteboard is used for projection storage according to this embodiment.

### DETAILED DESCRIPTION

A preferred embodiment of the present invention is illustrated in detail with reference to the accompanying drawings, so that the advantages and features of the present invention can be understood by those skilled in the art more easily, so that the protection scope of the present invention is defined more clearly.

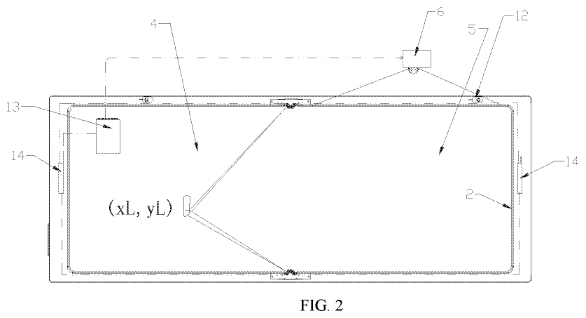

Referring to FIG. 2 to FIG. 4, an electronic whiteboard capable of simultaneous writing and projection storage according to this embodiment includes an electronic whiteboard body. An optical reflection bar 2 is disposed on an inner side of a frame 1 of the electronic whiteboard body. Two groups of infrared camera modules are disposed in the middle of the frame 1, where the two groups of the infrared camera modules are mirror-symmetrical on the left and right and separate the electronic whiteboard body into a left-region electronic whiteboard 4 and a right-region electronic whiteboard 5. Each group of the infrared camera module includes infrared cameras 3 disposed on upper and lower ends of the inner side of the frame 1, the two infrared cameras 3 on the left face the optical reflection bar 2 in the left-region electronic whiteboard 4, and the two infrared cameras 3 on the right face the optical reflection bar 2 in the right-region electronic whiteboard 5. Touch mainboards 14 of the left-region electronic whiteboard 4 and the right-region electronic whiteboard 5 are each connected to the two infrared cameras 3 of the electronic whiteboard in the corresponding region. That is, the touch mainboard 14 of the left-region electronic whiteboard 4 is connected to the two infrared cameras 3 (at upper and lower positions on the left) of the left-region electronic whiteboard 4, and the touch mainboard 14 of the right-region electronic whiteboard 5 is connected to the two infrared cameras 3 (at upper and lower positions on the right) of the right-region electronic whiteboard 5. A first projector 6 connected to the left-region electronic whiteboard 4/right-region electronic whiteboard 5 is disposed at the top of the left-region electronic whiteboard 4/right-region electronic whiteboard 5. The left-region electronic whiteboard 4 and the right-region electronic whiteboard 5 are each provided with a built-in touch mainboard 14. The touch mainboard 14 of the left-region electronic whiteboard 4/right-region electronic whiteboard 5 without the first projector 6 is connected to an input end of a computer host of an electronic whiteboard computer 13. An output end of the computer host is connected, through the first projector 6, to the touch mainboard 14 of the left-region electronic whiteboard 4/right-region electronic whiteboard 5 that is provided with the first projector 6. The electronic whiteboard in the region at one side (such as the left-region electronic whiteboard 4) sets a control instruction by using a whiteboard program installed in the electronic whiteboard computer 13 to perform conversion and transmits an HDMI signal to the first projector 6 at the top of the electronic whiteboard in the other region (such as the right-region electronic whiteboard 5), so as to project a writing track and touch position information onto the electronic whiteboard (such as the right-region electronic whiteboard 5) in the other region in real time. Besides, written content is captured at any time by using an electronic whiteboard program, and the content is stored in the electronic whiteboard computer 13 in the form of electronic information.

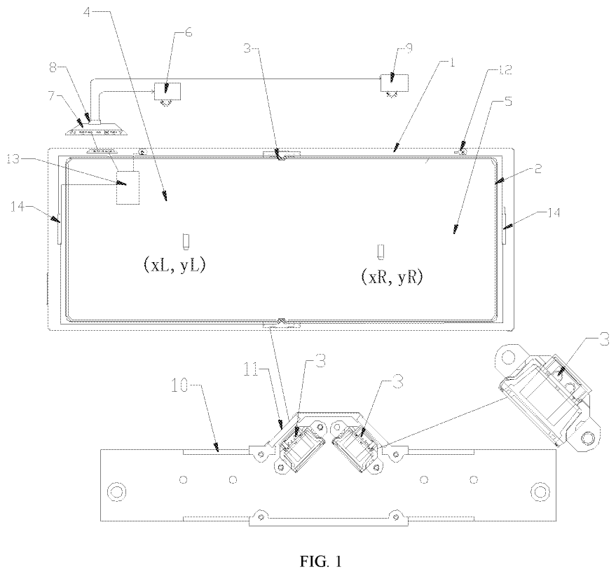

As shown in FIG. 1, the electronic whiteboard capable of simultaneous writing and projection storage further includes a second projector 9. The first projector 6 and the second projector 9 are correspondingly disposed at the top of the left-region electronic whiteboard 4 and the top of the right-region electronic whiteboard 5. That is, the first projector 6 is disposed at the top of the left-region electronic whiteboard 4, and the second projector 9 is disposed at the top of the right-region electronic whiteboard 5. Output ends of the touch mainboard 14 of the left-region electronic whiteboard 4 and the touch mainboard 14 of the right-region electronic whiteboard 5 are connected to the computer host of the electronic whiteboard computer 13. A computer host adapter board 7 is disposed above the electronic whiteboard computer 13. An output end of a PRS module 8 of the computer host adapter board 7 is connected to input ends of the first projector 6 and the second projector 9 through HDMI cables respectively, thus meeting the requirement of a whole-picture touch operation on a super-large full screen. The projectors connect electrical signals of the touch regions of the electronic whiteboard to the PRS module through the HDMI cables, and the PRS module 8 projects electrical signal information to the entire electronic whiteboard.

The output end of the PRS module 8 of the computer host adapter board 7 is connected to an input end of a projection fusion machine. An output end of the projection fusion machine is connected to the input end of the first projector 6 and the input end of the second projector 9 respectively. The projection fusion machine is built in the computer host adapter board 7. In combination with an image edge fusion program of the projection fusion machine, the PRS module 8 gradually lowers the brightness of an overlapping part between images of the two projectors, so that the brightness of the whole picture is consistent, and the color of the overlapping area is consistent with colors nearby. Images of two or more projectors are fused to build a display system with a super-large screen, thus forming an integrated image page that can display high-definition images.

An assembly direction of a lens of each infrared camera 3 is set at an angle of 45° with respect to an upper edge/a lower edge of the frame, so as to reduce touch blind regions and edge interference. The two groups of the infrared camera modules are disposed at a middle position, a left position or a right position of the frame 1.

The infrared cameras 3 are disposed in a camera corner fitting base 10. AR glass 11 is attached at a visual angle window of the camera corner fitting base 10. Two sides of a glass substrate of the AR glass 11 are coated with multiple layers of anti-reflection films. The substrate is subject to high-temperature heating in a vacuum furnace as well as surface auxiliary material evaporation and vaporization processes, so that multiple layers of anti-reflection films are coated on two sides of the glass to change the reflection direction and wavelength of incident light on the surface of the glass, thus reducing reflection energy loss when the light passes through the glass, hence increasing effective light transmittance of the glass and also increasing the glass strength. As such, it is prevented that dust enters the infrared camera 3 or the lens surface of the infrared camera 3 is damaged by an external force. Moreover, normal touch operations of the electronic whiteboard will not be affected due to high optical loss of external components.

The frame 1 of the left-region electronic whiteboard 4 and the right-region electronic whiteboard 5 is provided with built-in 3D high-definition iris cameras 12 at the top. The 3D high-definition iris cameras 12 are connected to the electronic whiteboard computer 13. An iris photographing technology is used for facial recognition and gesture control as well as daily network video interaction, and so on.

The computer host adapter board 7 is disposed above the rear of the electronic whiteboard body, thus facilitating transmission between multiple external electronic products and the computer of the electronic whiteboard, expanding the product usage range, and making wiring of the external electronic products neat and beautiful.

This embodiment has three functions, including an ordinary whiteboard writing function, a full-screen operation function, and a function of writing on the whiteboard on one side and projection storage on the whiteboard on the other side. Switching among the three functions is carried out by using a physical button or an electronic whiteboard program. The touch region and visual angle for watching are expanded; teaching and meeting efficiency as well as an interaction effect on and off the stage is enhanced. The product has a compact structure and simple operations, hence meeting flexible using requirements of users.

When the ordinary whiteboard writing function is used, the touch function of the left-region electronic whiteboard 4 and/or the right-region electronic whiteboard 5 is turned off, and thus writing can be performed.

When the full-screen operation function is used, the touch functions of the left-region electronic whiteboard 4 and the right-region electronic whiteboard 5 are both turned on. The electronic whiteboard computer 13 can projects videos or pictures in the electronic whiteboard computer 13 to the electronic whiteboard body through the first projector 6 and the second projector 9. If a touch operation needs to be performed, the left-region electronic whiteboard 4 and the right-region electronic whiteboard 5 respectively use an infrared touch triangle algorithm to perform calculation and analysis on data to obtain touch position information and a writing track, and project the touch position information and the writing track to the electronic whiteboard body through the respective corresponding first projector 6 and second projector 9.

When the whiteboard on one side is used for writing and the whiteboard on the other side is used for the projection storage function,

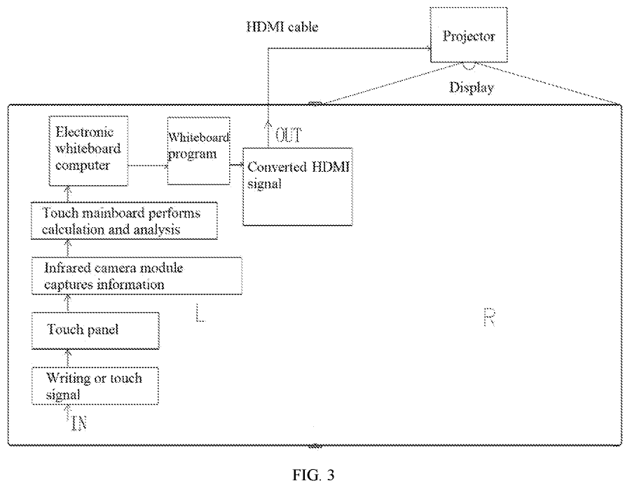

1) Taking the left-region electronic whiteboard 4 used for writing and the right-region electronic whiteboard 5 used for projection storage as an example, as shown in FIG. 2 and FIG. 3, when a touch or writing operation is performed on the left-region electronic whiteboard 4, light-sensitive chips of the two vertically adjacent infrared cameras of the left-region electronic whiteboard 4 capture light signals and transmit the light signals to the touch mainboard 14 of the left-region electronic whiteboard 4. The touch mainboard 14 of the left-region electronic whiteboard 4 uses an infrared touch triangle algorithm to perform calculation and analysis on data to obtain touch position information and a writing track. The touch mainboard of the left-region electronic whiteboard 4 transmits captured data signals such as a marker writing coordinate track to the computer host in real time. The computer host transmits the marker writing coordinate track to the first projector 6 at the top of the right-region electronic whiteboard 5. The touch position information and the writing track on the left-region electronic whiteboard 4 are projected on the right-region electronic whiteboard 5. In this case, the effect of writing on the left-region electronic whiteboard 4 and projection storage on the right-region electronic whiteboard 5 is achieved.

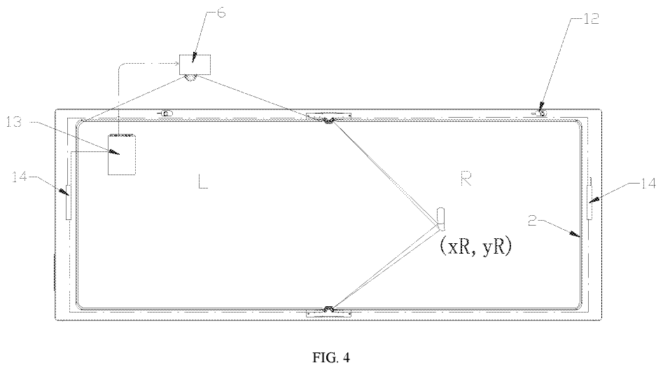

2) Taking the right-region electronic whiteboard 5 used for writing and the left-region electronic whiteboard 4 used for projection storage as an example, as shown in FIG. 4, when a touch or writing operation is performed on the right-region electronic whiteboard 5, light-sensitive chips of the two vertically adjacent infrared cameras of the right-region electronic whiteboard 5 capture light signals and transmit the light signals to the touch mainboard 14 of the right-region electronic whiteboard 5. The touch mainboard 14 of the right-region electronic whiteboard 5 uses an infrared touch triangle algorithm to perform calculation and analysis on data to obtain touch position information and a writing track. The touch mainboard of the right-region electronic whiteboard 5 transmits captured data signals such as a marker writing coordinate track to the computer host in real time. The computer host transmits the marker writing coordinate track to the first projector 6 at the top of the left-region electronic whiteboard 4. The touch position information and the writing track on the right-region electronic whiteboard 5 are projected on the left-region electronic whiteboard 4. In this case, the effect of writing on the right-region electronic whiteboard 5 and projection storage on the left-region electronic whiteboard 4 is achieved.

The left-region electronic whiteboard 4/right-region electronic whiteboard 5 captures written content at any time by using an electronic whiteboard program, and the written content is stored in the electronic whiteboard computer 13 in the form of an electronic document, thus facilitating retrieval and archiving, and enhancing the teaching and meeting efficiency as well as an interaction effect on and off the stage. The structure of the electronic whiteboard is combined in a mirror-symmetrical manner according to the infrared touch principle. Full-projection and full-touch can be implemented by using electronic whiteboard software and an image recognition module. The foregoing implementation is merely used for illustrating the technical conception and characteristics of the present invention, and is intended to enable those skilled in the art to understand and implement the content of the present invention. The protection scope of the present invention is not limited by the implementation. Any equivalent change or modification made based on the spiritual substance of the present invention should fall in the protection scope of the present invention.

1. An electronic whiteboard capable of simultaneous writing and projection storage, comprising an electronic whiteboard body, an optical reflection bar (2) being disposed on an inner side of a frame (1) of the electronic whiteboard body, wherein two groups of infrared camera modules are disposed in the middle of the frame (1), the two groups of the infrared camera modules are mirror-symmetrical on the left and right and separate the electronic whiteboard body into a left-region electronic whiteboard (4) and a right-region electronic whiteboard (5); each group of the infrared camera module comprises infrared cameras (3) disposed on upper and lower ends of the inner side of the frame (1), the two infrared cameras (3) on the left face leftwards, and the two infrared cameras (3) on the right face rightwards; touch mainboards (14) of the left-region electronic whiteboard (4) and the right-region electronic whiteboard (5) are each connected to the two infrared cameras (3) of the electronic whiteboard in the corresponding region; a first projector (6) connected to the left-region electronic whiteboard (4)/right-region electronic whiteboard (5) is disposed at the top of the left-region electronic whiteboard (4)/right-region electronic whiteboard (5); the left-region electronic whiteboard (4) and the right-region electronic whiteboard (5) are each provided with a built-in touch mainboard (14); the touch mainboard (14) of the left-region electronic whiteboard (4)/right-region electronic whiteboard (5) without the first projector (6) is connected to an input end of a computer host of an electronic whiteboard computer (13); and an output end of the computer host is connected, through the first projector (6), to the touch mainboard (14) of the left-region electronic whiteboard (4)/right-region electronic whiteboard (5) that is provided with the first projector (6).

2. The electronic whiteboard capable of simultaneous writing and projection storage according to claim 1, further comprising a second projector (9), wherein the first projector (6) and the second projector (9) are correspondingly disposed at the top of the left-region electronic whiteboard (4) and the top of the right-region electronic whiteboard (5); output ends of the touch mainboard (14) of the left-region electronic whiteboard (4) and the touch mainboard (14) of the right-region electronic whiteboard (5) are connected to the electronic whiteboard computer (13); a computer host adapter board (7) is disposed above the electronic whiteboard computer (13); an output end of a Picture Recognition System (PRS) module (8) of the computer host adapter board (7) is connected to input ends of the first projector (6) and the second projector (9) through HDMI cables respectively.

3. The electronic whiteboard capable of simultaneous writing and projection storage according to claim 2, wherein the output end of the PRS module (8) of the computer host adapter board (7) is connected to an input end of a projection fusion machine, an output end of the projection fusion machine is connected to the input end of the first projector (6) and the input end of the second projector (9) respectively, and the projection fusion machine is built in the computer host adapter board (7).

4. The electronic whiteboard capable of simultaneous writing and projection storage according to claim 1, wherein an assembly direction of a lens of each infrared camera (3) is set at an angle of 45° with respect to an upper edge/a lower edge of the frame (1).

5. The electronic whiteboard capable of simultaneous writing and projection storage according to claim 1, wherein the two groups of the infrared camera modules are disposed at a middle position, a left position or a right position of the frame (1).

6. The electronic whiteboard capable of simultaneous writing and projection storage according to claim 1, wherein the infrared cameras (3) are disposed in a camera corner fitting base (10), AR glass (11) is attached at a visual angle window of the camera corner fitting base (10), two sides of a glass substrate of the AR glass (11) are coated with multiple layers of anti-reflection films.

7. The electronic whiteboard capable of simultaneous writing and projection storage according to claim 1, wherein the frame (1) of the left-region electronic whiteboard (4) and the right-region electronic whiteboard (5) is provided with built-in 3D high-definition iris cameras (12) at the top, and the 3D high-definition iris cameras (12) are connected to the electronic whiteboard computer (13).

8. The electronic whiteboard capable of simultaneous writing and projection storage according to claim 1, wherein the computer host adapter board (7) is disposed above the rear of the electronic whiteboard body.
